(19) United States
(12) Patent Application Publication
(10) Pub. No.: US 2007/0083384 A1
(43) Pub. Date: Apr. 12, 2007

(54) Method and system for posture awareness training

(75) Inventors: David S. Geslak, Darien, IL (US); Suzanne M. Gray, Burr Ridge, IL (US); Joseph J. Bresingham, Oswego, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Right-Fit Education LLC, Burr Ridge, IL (US)

(21) Appl. No.: 11/237,266

(22) Filed: Sep. 28, 2005

(51) Int. Cl. G06Q 10/00; G06Q 50/00

(52) U.S. Cl. 705/2

(57) ABSTRACT

A system is provided for capturing a plurality of digital images of a given person for providing posture analysis and posture awareness training. The images may be displayed in a screen along with interactive vertical lines (vertical axis) and horizontal lines (top, bottom, and middle). An orthogonal gridline may be scaled by converting a physical mesh size provided by a user to a pixel mesh size and then overlaid on the image to assist in posture analysis. The system retains a historical record for the given person so that posture and training effectiveness may be tracked over time. Generally, anterior, posterior, and/or lateral images of the given person are used to analyze posture. In a further embodiment, a footpad may be used to provide indications for placement of the vertical and/or horizontal lines.

### BACKGROUND

1. Field of the Invention

The present invention relates to electronic systems and methods for posture assessment using computer manipulated digital photography.

2. Description of Related Art

For centuries, it has been known that an individual's posture plays an important role in promoting health throughout life. Yet, even today it is quite common to find persons with rounded or misaligned shoulders, core weakness, and general muscular weakness.

A method for identifying problematic posture is outlined in the book Muscles. Testing and Function, 4^{th} ed. By Florence Peterson Kendall, which is hereby incorporated by reference. Kendall's book discloses the use of photographs to teach students elements of correct posture. In Kendall, an orthogonal grid is shown on a wall and a plumb line is also disclosed. The plumb line is a physical piece of cord attached to a small lead weight known as a plumb bob. When suspended, the cord creates a vertical line that may be used as a reference. To use the plumb line as a vertical axis when analyzing standing posture, the cord must be suspended in line with fixed body points.

A simple digitized photography system for posture analysis, known as the Posture Analyzer, has been produced by Posture-It for sale to chiropractic specialists. The Posture-It Posture Analyzer displays a photograph of a prospective client and allows movement of perpendicular lines to demonstrate postural asymmetries.

VenturaDesigns produces PosturePro, a software product for posture analysis that operates by locating joint angles and measuring various distances between body points. For instance, the PosturePro may draw a line from the ASIS to the center of the kneecap, and a line drawn from the center of the knee cap to the Tibial tuberosity.

According to the PosturePro analysis method, an angle formed by the intersection of these two lines should be less than 20 degrees in men and 25 degrees in women. The higher value for women is due to a wider pelvic stance. PosturePro also allows for an assessment of deviation from a plumb line and provides a “posture number.”

PosturePro requires that anatomical markers be placed on the body (or on the person's clothing).

The National Academy of Sports Medicine (NASM) produces The Body Map, a web-based movement assessment tool that is intended to help detect muscle imbalances. The Body Map uses digital photography of a client during dynamic movements. An individualized exercise regimen may then be generated based on an analysis of the photographs.

The Posture Company produces AlignaBod, an orthogonal grid made of a vinyl material that that may be attached to a wall. A photograph may then be taken of the client standing in front of the grid. The grid may be used to provide a reference when measuring posture alignment. However, relevant gridlines are blocked by the client's body, and the physical difference between the location of the client's body and the location of the grid can lead to difficulty in measuring and other problems with perspective.

### SUMMARY

Posture has been shown to be an important indicator and factor of health and wellbeing for persons of all ages. In addition, posture awareness training has been shown to significantly improve posture for many individuals suffering from poor or misaligned posture. A method and system is disclosed for improved posture assessment and for posture awareness training.

According to an exemplary embodiment, digital photographs are taken of a person standing from anterior, lateral, and posterior perspectives. The digital photographs are then received by a computer and stored in a database configured to retrievably store records for any number of persons.

The database records associated with each person may include personal identification information such as name and identification number as well as data that may be important for making a posture assessment or for developing an individualized posture awareness training program such as height, weight, and age. Additional qualitative or quantitative data may be included as well. The database records may further include historical data to indicate how each person's posture related data have changed over time. Thus, for instance, the database records may include annual digital images and height/weight measurements. Once a posture assessment has been made, the database records may include an indication of the assessment and/or the posture awareness training program.

One aspect of the system provides a display of an image of the person standing in a first position (e.g., anterior, posterior, or lateral). A vertical line is overlaid on the image. The vertical line may be adjusted so that it serves as a vertical axis. For example, the vertical line may be adjusted to be midway between the heels in a posterior view or just anterior to the lateral malleolus in a lateral view. Alternatively, the vertical line may be adjusted to align with a marker on a footpad located under the person.

Horizontal lines may also be overlaid on the image. For instance, a first horizontal line may be associated with a top of the person's head while a second horizontal line may be associated with the bottom of the person's feet. The distance between the two lines is then useful for creating a scale factor for determining how distance on the user output (a pixel distance) correlates to a physical distance on the person's body. Horizontal lines may further be used to indicate other body locations, such as a body midpoint, shoulder height, hip location, etc. The horizontal lines can provide information to chart growth, determine muscle imbalances and measure the distance between two body points. In the exemplary embodiment the horizontal lines are adjustable by a user.

Further, an orthogonal grid consisting of a series of vertical and horizontal lines may be overlaid on the image. According to the exemplary embodiment, the user may provide a physical grid size that is then used to calibrate the distance between each line of the grid as displayed. Because a digital grid is overlaid in the image there is no need for a physical grid to be used.

### BRIEF DESCRIPTION OF THE DRAWINGS

FIG. 1 is a block diagram showing an exemplary posture analysis system.

FIG. 2 is a block diagram showing an exemplary program code.

FIG. 3 is a flow chart showing operation of a posture analysis system.

FIGS. 4-6 show exemplary user displays in the posture analysis system.

FIG. 7 shows an exemplary footpad.

### DETAILED DESCRIPTION OF THE DRAWINGS

1. Exemplary System

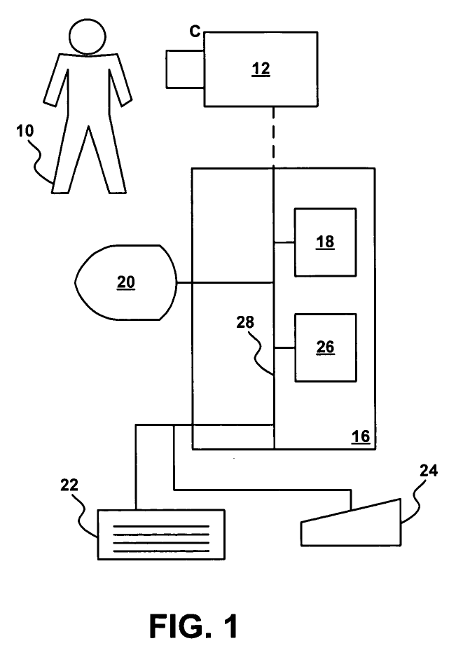

FIG. 1 is a block diagram showing an exemplary posture analysis system. A digital camera 12 may be used to photograph a given person 10. A computing system 16 is available to receive the digital image captured by the camera 12. The computing system 16 includes a processor 18 and data storage 26 communicatively coupled via a bus 28. A user output, such as a display 20, may be communicatively coupled with the computing system 16. Likewise user input devices such as a keyboard 22 or a mouse 24 may be communicatively coupled with the computing device.

The digital camera 12 may be any camera capable of capturing an image of the given person 10 and storing that image in a format readable by the computing system 16. Typical storage formats include GIF, JPG, TIFF and others. The camera 12 may be directly coupled with the computing system 16 via a wire or wireless communication link for real-time transfer of the digital image. Alternatively, photographs may be taken by the camera 12 when ‘offline’ or not connected to the computing system 16. In that case, a nonvolatile memory or data storage may be used to transfer the digital image file from the camera to the computing system 16. In various embodiments, the image may be compressed, transformed, or consolidated prior to transfer for any number of reasons including easing the transfer and limiting storage space. In the exemplary embodiment, the digital image captured by the digital camera 12 is taken with the camera 12 positioned approximately at a predetermined distance from the person 10 to better ensure validity and reliability in the images. In an alternative embodiment, the camera may be located within a broader range of distances to ensure photo quality without sacrificing ease of use. In that embodiment, a computer code may operate to ensure consistency in relative image scale.

It is expected that the camera 12 will be used in conjunction with a tripod or other stabilizer to better ensure (1) the predetermined distance, (2) consistency between photos, and (3) photo quality.

The processor 18 may be a microprocessor or other hardware configured to interoperate with data storage and to execute machine readable program code. The processor 18 may be a single hardware device. Alternatively, the processor 18 may be a distributed processor comprising a plurality of hardware devices.

Data storage 26 may store records associated with a posture assessment database, computer code that is executable by the processor, and other materials. According to the exemplary embodiment, data storage is a computer hard drive although the data storage 26 may generally be any device or set of devices capable performing the described functions. This would include, for instance, many other types of nonvolatile memory. Data bus 28 may be an internal bus configured to provide rapid binary communication between the various elements of the computing system 16 and to and from the various external devices. The bus 28 may be configured in parallel or in series. In another embodiment, the bus 28 may be replaced with another device for providing communication between the elements. In a further embodiment, the data storage 26 may be directly coupled with the processor 18. A user interacts with the posture assessment system through the user input and output devices. It is important for the screen 20 have an ability to display digital images.

In a further embodiment, the computing system 16 along with the user input and output are all configured on a single handheld device such as a PDA-type device. In a further embodiment, the handheld device further includes the camera 12. This embodiment beneficially provides superior portability that may not be otherwise available. Because a digital grid is overlaid in the image there is no need for a physical grid to be used—thus saving additional space and further facilitating portability.

Program code may be stored in data storage 26 and may be configured in a number of ways. In the exemplary embodiment, the program code is compiled as machine language code that is ready for execution by the processor through an operating system. Alternatively, the code may persist in a precompiled or partially compiled state.

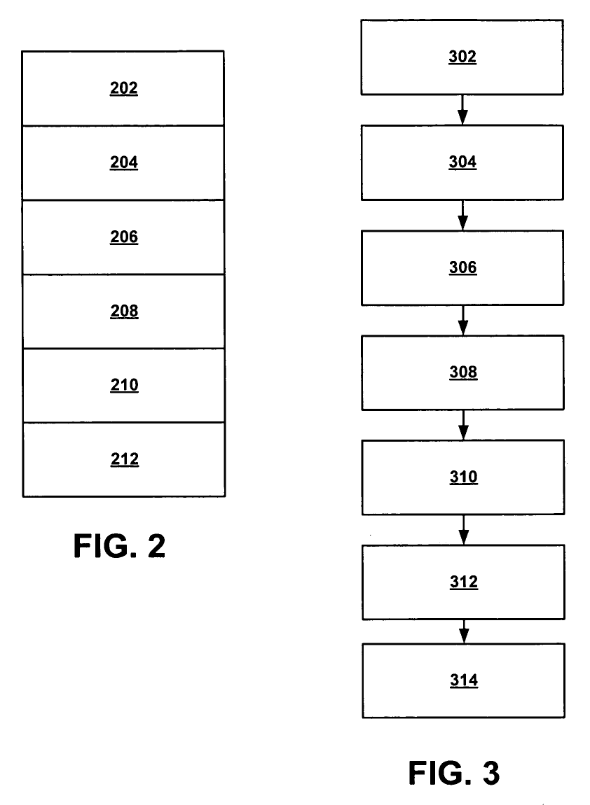

Logically, the program code may be separated into a number of instruction sets. In the exemplary embodiment, however, the logical separation is not reflected by a physical separation in the compiled code. Thus, for instance, a first logical set of instructions may be intermingled with a second logical set of instructions. FIG. 2 is a block diagram showing an exemplary program code divided into a number of logical instruction sets including in permissive combination:

(202) Instructions for storing, accessing, and modifying records relating to a plurality of persons who are being provided posture analyses and/or posture assessment training. These records may be stored in a database in data storage 26. There may be multiple records associated with each person. These multiple records may provide for historical tracking of posture, for instance. Each historical record may include a date indicator for indicating a historical reference point in time, a digital image, a height, weight, and age of associated with the person at that historical reference point. Each historical record may further include a postural assessment for the person and/or an individualized posture awareness training program.

(204) Instructions for associating a digital image file with a first record associated with a first person. In an embodiment, the digital images associated with each person are stored in the database. In an alternative embodiment pointers or other references to the images are stored in the database.

(206) Instructions for displaying the digital image file at a user output. In the exemplary embodiment there may be multiple digital images associated with the person. One type of image, such as an anterior view, may be pre-designated as the default image to be shown when the person's records are displayed. Further, a user may select which of the images should be shown. In various embodiments, the selection process may be done by selecting an image type from a set (such as a list or set of buttons), selecting an image from a set, for instance.

(208) Instructions for displaying an interactive vertical line overlaid on the image at the user output for providing a vertical axis as a posture reference. In an embodiment, through the instructions, a user may relocate the vertical line through the user input devices, such as a mouse. In another embodiment, the instructions include code for discovering a vertical axis location indicator within the digital image. This indicator may be a marker in a footpad, a marker placed on the person's body, or a calculated location, for instance. Once the indicator is located, vertical line may be displayed so that it passes through the vertical axis location indicator.

(210) instructions for displaying at least two interactive reference indicators overlaid on the image at the user output for determining a scale factor. According to the embodiment, the interactive reference indicators are horizontal lines associated. To create the scale factor, one line may be associated with the top of the person's head in the image while the other line is associated with the bottom of the person's feet. The distance between these lines may then be compared with a physical height of the person to create the scale factor. According to a further embodiment, the user may adjust the location of the horizontal lines through a user input device such as the mouse or keyboard or via a touchpad screen.

(212) Instructions for displaying an orthogonal grid overlaid on the image at the user output for further facilitating postural assessment. The grid size of the orthogonal grid may be figured according to the scale factor. The scale factor relates a physical distance on the person's body to a pixel distance (or a distance on the screen) of the digital image showing the person. Thus, the user may provide a physical grid mesh size as a physical distance relating to the person's body. Using the instructions, that physical grid mesh size may then be converted to a pixel-type grid mesh size using the scale factor and displayed with each parallel gridline separated by the pixel-type grid mesh size.

In the embodiment, other logical instruction sets may be useful for implementation of the program code. Those sets are known to those skilled in the art. The above listed instruction sets can be combined in various combinations. As such, the listing is not intended to require each and every instruction set in each embodiment. For instance, in various embodiments, instruction set 212 or 210 or both 212 and 212 may be excluded.

2. Exemplary Operation

FIG. 3 is a flow chart showing an exemplary operation of a posture assessment system at a data processing machine, such as a computing system or computer. The chart shows the steps of:

(302) The computing system receives a digital image file that includes an image representative of a given person standing in a first position. Thus, the image may show the given person from a first perspective, such as posterior, anterior, or lateral. Further, the image may show the given person performing a particular action such as lifting a weight, bending, stretching, etc. The image file may be stored at the computing system in data storage located either within or external to the computing system.

(304) The digital system may be associated with a data record for the given person. In the embodiment, the data record is one of a plurality of data records and stored in data storage accessible to a data processor.

(306) The image may be displayed at the user output.

(308) An interactive vertical line may be overlaid on the image. The vertical line may be displayed for providing a vertical axis as a posture reference or for other reasons. In the exemplary embodiment, the vertical line is colored and sized to be easily visible when overlaid on the image. Displaying the interactive vertical line may also include allowing the user to adjust the position of the vertical line or autonomously adjusting the vertical line. For instance, the vertical line may be adjusted so that it corresponds with a predetermined point on the given person's body or with a marker visible in the image.

(310) Reference indicators may be overlaid on the image. The reference indicators may be useful for taking measurements, determining a scale factor, or for other reasons. In an embodiment, the reference indicators may be vertical lines or horizontal lines. In an exemplary embodiment, a pair of indicators may be displayed for calculating a distance between two body points. In a further embodiment, a reference indicator may indicate the location of one of the top of the head, shoulders, top of the hip, bottom of the feet, etc. Labels may be added to each reference point to indicate the type of point—for instance one reference may be labeled “top” while another labeled “bottom.” In the exemplary embodiment, these labels may be placed at an edge of the displayed image.

(312) An orthogonal grid may be overlaid on the image. The orthogonal grid may be overlaid for further facilitating the posture assessment or for other reasons. In an embodiment, the orthogonal grid is overlaid after receiving a user command via a user input.

(314) A posture assessment or posture awareness training program for the given person may be requested based on the digital image.

It should be noted that, although FIG. 3 shows a process flow in a certain order, the steps should be thought of as occurring in combination such that the steps may occur in various orders according to user requests and/or other considerations. Further, this disclosure should not be seen as limiting the method of operation as including each and every one of the listed steps or as restricting the method to only the steps listed. In addition, the steps may be further modified as disclosed or as may be easily recognized by those skilled in the art.

3. Exemplary Display

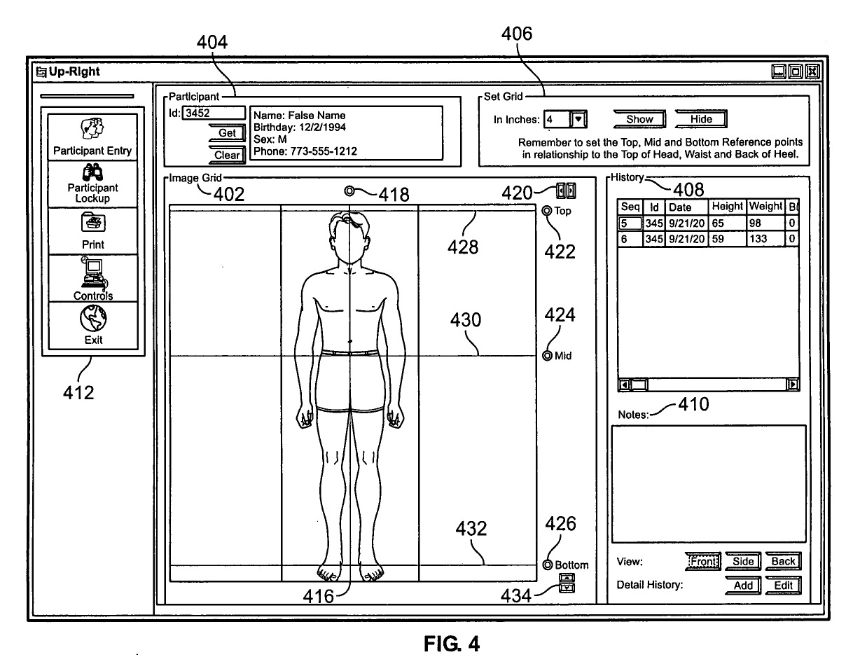

FIG. 4 provides a screen shot showing an exemplary embodiment of the posture analysis system as would be seen by a user at a user output such as a screen. The screen serves as a graphical user interface (GUI) and is divided into a number of segments. A menu segment 412, a participant segment 404, an image grid segment 402, a set grid segment 406, a history segment 408, and a notes segment 410.

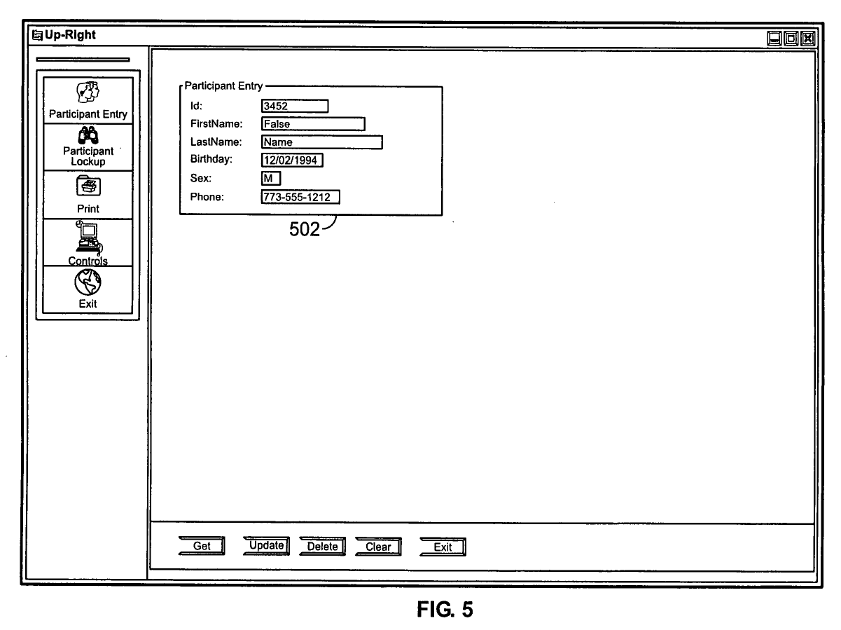

The menu segment 412 provides for various menu options available to a user including participant entry, participant lookup, print, controls, and exit. The participant entry menu option allows a user to add, delete, and update participant identification information through a participant entry segment 502 as shown in FIG. 5. Although not limiting, the identification information may include an identification number (or alphanumeric), a name, a birth date, a sex (m/f), and/or a telephone number. Further, the identification information may include other elements such as parent or guardian information, links to school records or class schedule, home address, medical history, etc.

The participant segment 404 allows a user to lookup a stored record for a given person based on an identification number. More nuanced lookup features are available via the participant lookup menu option. Once a record is found, the participant segment 404 displays a listing of participant information. In the example shown by FIG. 4, the name, birthday, sex and phone number of the given person are shown.

The image grid segment 402 provides a display of an image of the given person. A frontal or anterior image (cartoon) is shown in FIG. 4 as a representation of the image. A vertical line 416 passes from the bottom of the image to the top of the image and may represent a vertical axis for posture analysis. A first radio button 418 may be movable by a user entering commands at a user input device such as a mouse (drag and drop). When the first radio button 418 is moved, the vertical line 416 correspondingly moves. If the first radio button 418 is selected, a first fine adjustment 420 may be used to adjust the location of the vertical line (left or right).

Three horizontal lines are shown: a top horizontal line 428, a mid horizontal line 430, and a bottom horizontal line 432. Each line has a corresponding radio button: a top radio button 422, a mid radio button 424, and a bottom radio button 426, respectively. The each radio button may be moved to move its corresponding horizontal line. A second find adjustment 434 may be used to adjust the location of a horizontal line (up or down) having its radio button selected.

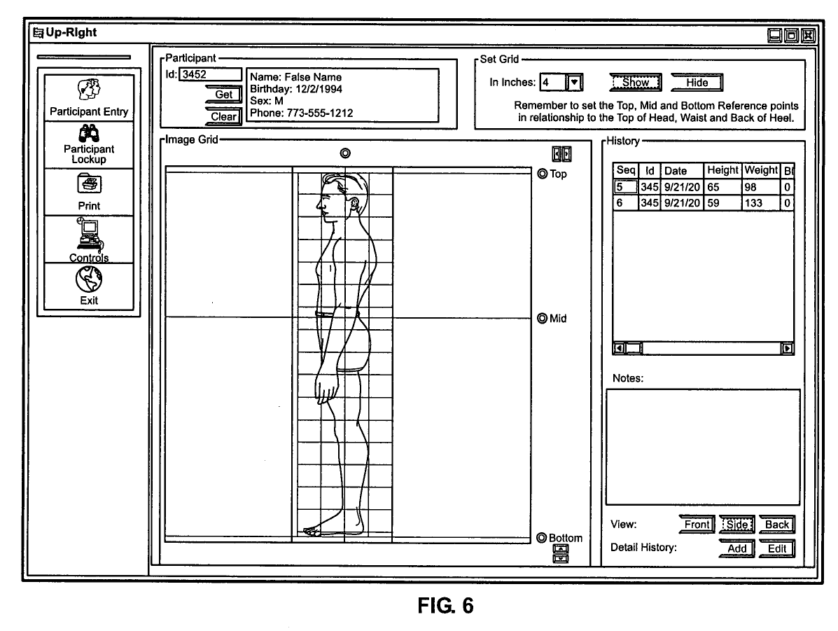

The set grid segment 406 provides a user with an option for generating an orthogonal grid overlay and for determining a grid mesh size. In the embodiment, the user may select a grid mesh size (in inches) that corresponds to a physical distance on the given person's body. A show button will then cause the orthogonal grid to be shown in the image grid segment 402. In FIG. 6, a lateral image of the given person is shown with the grid overlay.

The top and bottom horizontal lines 428, 432 are used to create a scale factor that is compared with a physical height of the person. The scale factor is then used to convert the physical grid mesh size to a pixel-type grid mesh size that is shown on the screen.

The horizontal lines may also provide information to chart growth, determine muscle imbalances and measure the distance between two points (e.g., distance between the top of the shoulders and the top of the hips).

The history segment 408 allows a user to view records associated with the given person from various historical periods. This allows for posture assessment to be tracked over time to determine changes in posture and treatment effectiveness. Further, this format enables the instructor to easily record data, progress and maintain yearly growth and development.

A further segment or menu item (or other option) may allow a user to provide further assessment information. The assessment information may provide various scores or yes/no marks for the persons results on a battery of test. The tests may focus on the following, for instance: range of motion (ROM) analysis, core analysis, trunk builder, push-up complex, endurance engine, and limber right. ROM analysis may assess range of motion in the neck and flexibility of the shoulder girdle. Core analysis may focus on abdominal muscle contraction ability, strength and endurance. Trunk builder may focus on gluteal and hamstring strength, and the strength of low back muscles. The push-up complex looks to arm and shoulder strength and endurance. The endurance engine may be a three-minute exercise test to assess the cardio-respiratory system. Finally, the limber right focuses on flexibility of the legs and back.

The print menu option of the menu segment provides the ability to create and print individualized reports for the given person. According to an embodiment, a report may include at least one image of the person along with the horizontal, vertical and/or grid lines. Identification information as well as results of the assessment information may also be provided. A historical report may provide results over time so that posture changes can be compared in a side-by-side analysis.

4. Exemplary Footpad

In an embodiment, a footpad is placed under the person as the digital image is being captured. The footpad may provide various benefits, including facilitating proper foot positioning and creating a marker in the image for positioning of the vertical line.

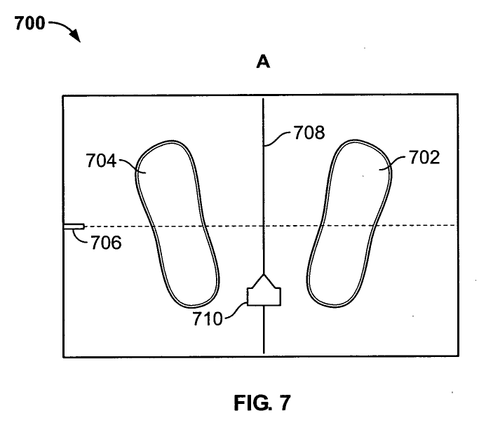

FIG. 7 provides an exemplary footpad 700. In an embodiment, footpad includes marked foot locations 702, 704 for positioning each foot. Alternatively, the footpad may provide other indications for assisting the person in feet positioning such that a frontal midline 708 is equidistant from each foot. A frontal marker 710 provides an indication of the back of the heel and may be useful in setting a location of the bottom horizontal line and for setting a location of the vertical line for a frontal image (taken from position A). For a lateral image (taken from position B), a lateral midline 706 may be useful in positioning of the vertical line.

In an embodiment, the frontal marker 710 is a raised block and is colored the same color as the vertical line displayed on by the computing system at the user output. Likewise, the lateral midline 706 may include a raised block portion that is similarly colored to match with the vertical line. Thus, the footpad may operate in conjunction with the computing system and program code to ensure that the horizontal and vertical indicators are placed in their proper location.

5. Posture Awareness Training

After an individual is evaluated and photos have been taken an instructor can then refer to an associated manual prescribed exercises. An individualized posture awareness training program may be developed for the given person and will depend upon the posture evaluation and analysis.

In an embodiment, the manual is an age appropriate instructional text for youth and may further serve as a reference for parents, teachers and health educators. The manual may offer a comprehensive fitness assessment, and a state-of-the-art exercise program that can be administered in schools, community centers, health clubs and homes. Individual fitness assessments from the manual are helpful to: assess current fitness/wellness levels (strengths and weaknesses); identify special needs for individual exercise prescription (training/counseling); To evaluate progress; motivate, teach and educate each individual; and record and compare an individual's growth and development.

In a further embodiment, the instructor may provide an evaluation at a user input of the computer system - thus prompting the computer system to generate the posture awareness training program based on a digitized manual.

6. Conclusions

The methods and systems described are intended for use in posture analysis and posture awareness training. However, it is envisioned that these systems as described or with future modifications may be useful in other areas including musculoskeletal analysis and biofeedback treatment, for instance.

It should be emphasized that the above-described embodiments of the present invention, particularly, any “exemplary,” “preferred” or “alternative” embodiments, are merely possible examples of implementations set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Moreover, the claims should not be read as limited to the described order or elements unless explicitly stated to that effect. Thus, all variations that come within the scope and spirit of the following claims and equivalents thereto are claimed as the invention.

We claim:

1. A method of operating at least one programmable electronic data processing machine comprising:
receiving a digital image file comprising an image representative of a given person standing in a first position;
associating the digital image with a data record for the given person, wherein the data record is one of a plurality of data records and stored in a data storage accessible to the data processing machine;
displaying the image at a user output;
displaying an interactive vertical line overlaid on the image for providing a vertical axis as a posture reference;
displaying at least two reference indicators overlaid on the image for determining a scale factor; and
requesting a posture assessment of the given person based on the digital image.

2. The method of claim 1, further comprising:
displaying an orthogonal grid overlaid on the image for further facilitating the posture assessment.

3. The method of claim 2, further comprising receiving an a user input indicating a grid mesh size.

4. The method of claim 3, further comprising determining the scale factor by comparing a pixel-type difference between the two reference indicators with a physical distance between two physical reference indicators associated with points on the given person's body.

5. The method of claim 4,
wherein the two reference indicators include a first horizontal line and a second horizontal line, wherein the first horizontal line may be associated with a top of a head of the given person and the second horizontal line may be associated with a bottom of a foot of the given person and
wherein the physical distance is a height of the given person, and wherein the height of the given person is stored in a data record for the given person.

6. The method of claim 1, wherein the plurality of data records include a historical set of data records associated with the given person, wherein (i) changes in posture and (ii) treatment effectiveness may be tracked over time.

7. The method of claim 6, wherein the historical set of data records associated with the given person include at least one image associated with the given person for each of a plurality of historical points, and wherein each image is further associated with a data record indicative of a height, a weight, and an age of the given person at a given historical point.

8. The method of claim 1, wherein the image file is further representative of the given person standing on a footpad configured to facilitate positioning the vertical line.

9. A system for posture analysis comprising computer code stored in data storage and executable by a processor, the code comprising:
(i) instructions for retrievably storing records relating to a plurality of persons;
(ii) instructions for associating a digital image file with a first record associated with a first person;
(iii) instructions for displaying the digital image file at a user output;
(iv) instructions for displaying an interactive vertical line overlaid on the image at the user output for providing a vertical axis as a posture reference; and
(v) instructions for displaying at least two interactive reference indicators overlaid on the image at the user output for determining a scale factor.

10. The system of claim 9, the code further comprising:
(vi) instructions for displaying an orthogonal grid overlaid on the image at the user output for further facilitating postural assessment.

11. The system of claim 10, wherein the scale factor is a key for relating a physical distance between two parts of given person's body to a pixel-type distance between two points in the image file, the two points in the image file corresponding to the two parts of the given person's body.

12. The system of claim 1 1, wherein the (vi) instructions for displaying the orthogonal grid comprise:
(vi.a) instructions for receiving a physical grid mesh size from a user, the physical grid mesh size being a physical distance relative relating to the given person's body;
(vi.b) instructions for converting the physical grid mesh size to a pixel-type grid mesh size using the scale factor;
(vi.c) instructions for displaying the orthogonal grid, wherein each parallel gridline is separated by the pixel-type grid mesh size.

13. The system of claim 9, wherein the (i) instructions for retrievably storing records relating to the plurality of persons further includes instructions for storing historical records relating to each person, wherein each historical record comprises:
a date indicator indicating the historical reference point;
at least one digital image for posture assessment showing a posture of the person at the historical reference point;
a height of the person at the historical reference point;
a weight of the person at the historical reference point; and
an age of the person at the historical reference point.

14. The system of claim 13, wherein each historical record further comprises:
a postural assessment for the person; and
an individualized posture awareness training program.

15. The system of claim 9, wherein the wherein the two interactive reference indicators include a first horizontal line and a second horizontal line, wherein the first horizontal line may be associated with a top of a head of the given person and the second horizontal line may be associated with a bottom of a foot of the given person.

16. The system of claim 9, wherein a user may adjust a location of each horizontal line.

17. The system of claim 9, wherein the (iv) instructions for displaying the interactive vertical line overlaid on the image comprises:
(iv.a) instructions for discovering a vertical axis location indicator in the digital image;
(iv.b) instructions for displaying the vertical line such that the vertical line passes through the vertical axis location indicator.

18. The system of claim 17, wherein the vertical axis location indicator is a marker shown on a footpad.

19. A system for posture assessment comprising:
a footpad for positioning a person in a first position, the footpad including a marker as a vertical axis location indicator;
a digital camera for creating a first digital image of the person standing on the footpad in the first position;
data storage for storing a plurality of records associated a plurality of persons;
a processor for executing program code and for accessing data storage;
a user output; and
a program code executable by the processor for:
associating the first digital image with a record associated with the first person;
displaying the first digital image at the user output;
generating a vertical axis overlaid on the digital image, wherein the vertical axis passes through the vertical axis location indicator; and
calculating a grid scale factor for converting a physical distance to a pixel-type distance.

20. The system of claim 19, wherein the first position is a lateral position, and the marker provides an indication of a location anterior to the lateral malleolus.
